(19) United States
(12) Patent Application Publication
(10) Pub. No.: US 2004/0123863 A1
(43) Pub. Date: Jul. 1, 2004

(54) Method of controlling oxygen inhaling through involuntary action of human and product thereof

(76) Inventor: Yi-Hua Wang, (US)

Correspondence Address: Raymond Y. Chan, 108 N. Ynez Avenue, Suite 128, Monterey Park, CA, 91754, US

(21) Appl. No.: 10/329,845

(22) Filed: Dec. 27, 2002

(51) Int. Cl. A62B 7/00

(52) U.S. Cl. 128/200.24

(57) ABSTRACT

A method of controlling oxygen inhaling through an involuntary action of a user, includes the steps of generating a yawning influence signal periodically; applying the yawning influence signal through a media to the user; and contagiously stimulating the user to generate a sense of yawn by means of reflex action. Therefore, the user is able to subconsciously increase the oxygen inhaling into the human being and the carbon dioxide exhaling therefrom by means of involuntary action.

### BACKGROUND OF THE PRESENT INVENTION

1. Field of Invention

The present invention relates to a reflex action of a human being, and more particularly to a method of controlling an oxygen inhaling through an involuntary action of the human and a product thereof, which can strength the respiratory system of the human being and enhance the metabolism thereof.

2. Description of Related Arts

Although there is enormous variation between the external appearances of humans, all bodies contain the same basic features, such as the nervous system, the digestive system, the circulatory system, the respiratory system, and the urinary system. In order to keep these systems functioning, an energy which is in form of food and oxygen must be input into the human. The process of transforming the raw energy into a useful energy is called the metabolism wherein the metabolism is a process by which food is built up into living matter or by which living matter is broken down into simple substances.

Accordingly, when an individual eats the food, the food is burnt to be broken down into the simple substances for the individual body to absorb. During the breaking down process, oxygen is required as one of the major elements in the metabolism, such that the respiratory system of the individual supplies the oxygen needed by the body cell and carries off their carbon dioxide waste.

Since every individual needs oxygen, an act of breath is an involuntary action. Generally speaking, after finishing the meal, the individual needs oxygen to break down the food. During driving or deep thinking, the individual requires oxygen for the body cell functioning in an optimum condition.

Once the individual needs more oxygen, the individual is able to take a deep breath or use an oxygen mask. However, the most significant action of intaking large mount of the oxygen is yawning. When the individual yawns, the lung is fully expanded to fill the air therein. Unlike the deep breath, the yawning is an involuntary action that is not controlled by the will. Therefore, yawn is a reflex action of the human body and serves to bring in more air because low oxygen level is sensed in the lung. Moreover, due to the self-regulating system of the human body, the individual will keep automatically yawning until the human body intakes enough oxygen. In other words, the deep breath and the oxygen mask are voluntary actions which may be considered as a disturbance for the individual's concentration, especially when he or she is in brainstorm or driving.

### SUMMARY OF THE PRESENT INVENTION

A main object of the present invention is to provide a method of controlling an oxygen inhaling through an involuntary action of the human and a product thereof, which can strength the respiratory system of the human being and enhance the metabolism thereof.

Another object of the present invention is to provide a method of controlling an oxygen inhaling through an involuntary action of the human and a product thereof, which is capable of increasing the oxygen inhaling into the human being and the carbon dioxide exhaling therefrom by means of involuntary action.

Another object of the present invention is to provide a method of controlling oxygen inhaling through an involuntary action of the human and a product thereof, wherein a yawning influence signal is generated to stimulate the act of yawning by means of reflex action. In other words, the nervous system of the human body is stimulated by the yawning signal to involuntarily response through the yawning action without hazarding the health of the human being.

Another object of the present invention is to provide a method of controlling an oxygen inhaling through an involuntary action of the human and a product thereof, wherein the yawning influence signal is capable of being selectively adjusted its time interval and its frequency to fit the need of each individual.

Another object of the present invention is to provide a method of controlling an oxygen inhaling through an involuntary action of the human and a product thereof, which is easy and safe to use, such that once the individual lacks of oxygen during driving or deep thinking, he or she is able to operate the present invention to stimulate yawning, so as to keep the cell body functioning in an optimum condition.

Accordingly, in order to accomplish the above objects, the present invention provides a method of controlling oxygen inhaling through an involuntary action of a user, comprising the steps of:

(a) generating a yawning influence signal periodically;

(b) applying the yawning influence signal through a media to the user; and

(c) contagiously stimulating the user to generate a sense of yawn by means of reflex action.

### BRIEF DESCRIPTION OF THE DRAWINGS

FIG. 1 is a block diagram of an oxygen inhaling controlling system according to a preferred embodiment of the present invention.

### DETAILED DESCRIPTION OF THE PREFERRED EMBODIMENT

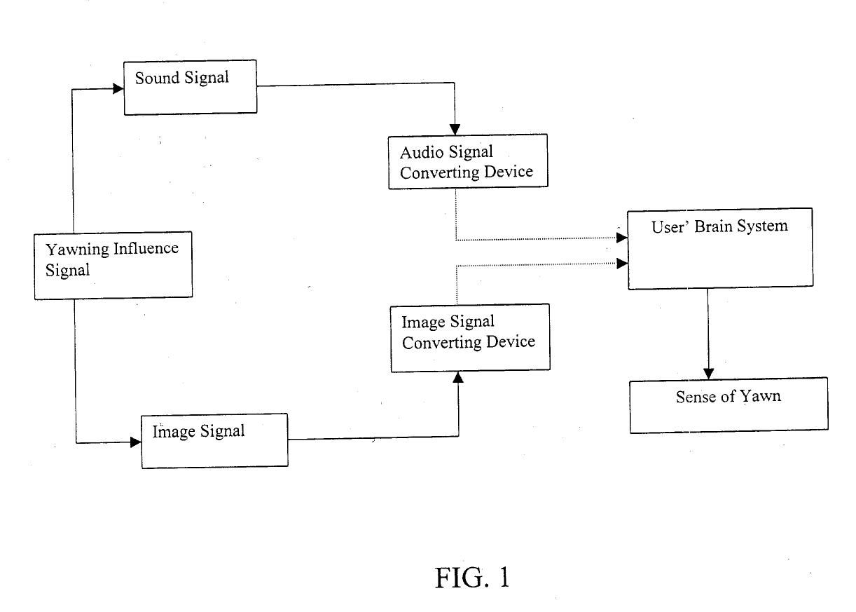

Referring to FIG. 1 of the drawings, a method of controlling oxygen inhaling through an involuntary action of a user according to a preferred embodiment of the present invention is illustrated, wherein one of the involuntary actions of a human is yawning.

The physiological theory states that a yawn is a reflex that occurs when the user's brain recognizes a need for more oxygen, wherein yawning is a deep usually involuntary intake of breath through a wide open mount often as an involuntary reaction to fatigue. In addition, human bodies induce yawning to drawn in more oxygen or remove a build-up of carbon dioxide. This theory helps explain why we yawn in groups. Larger groups produce more carbon dioxide, which means the human bodies would act to draw in more oxygen and get rid of the excess carbon dioxide. Therefore, the purpose of yawning actually seems to be to prime the brain for change to a more energized state.

Yawning is under the control of several neurotransmitters and neuropeptides at the central level. Among the substances, the best known are dopamine, excitatory amino acids, acetylcholine, serotonin, nitric oxide, adrenocorticotropic hormone-related peptides and oxytocin, that facilitate yawning and opioid peptides that inhibit this behavioral response. Some of the above compounds interact in the paraventricular nucleus of the hypothalamus to control yawning. This hypothalamic nucleus contains the cell bodies of oxytocinergic neurons projecting to extra-hypothalamic brain areas that play a key role in the expression of this behavioral event. When activated by dopamine, excitatory amino acids and oxytocin itself, these neurons facilitate yawning by releasing oxytocin at sites distant form the paraventricular nucleus, i.e. the hippocampus, the pons and/or the medulla oblongata. Conversely, activation of these neurons by dopamine, oxytocin or excitatory amino acids, is antagonized by opioid peptides, that, in turn, prevent the yawning response. The activation and inhibition, respectively of these oxytocinergic neurons is related to a concomitant increase and decrease, respectively, of paraventricular nitric oxide synthase activity. Nitric oxide is also involved in the induction of yawning by the latter compounds and neuronal links, for instance between dopamine and acetylcholine and dopamine and serotonin, seem to be involved in the yawning response. Finally, other neurotransmitters, i.e. gamma-aminobutyric acid (GABA) and noradrenaline, and neuropeptides, i.e. neurotensin and luteinizing hormone-releasing hormone (LH-RH), influence this behavioral response.

There are many parts of the body that are in action during yawning. First, the user's mouth opens and jaw drops, allowing as much air to be taken in as possible. When the user inhales, the air taken in is filling the user's lungs. The user's abdominal muscles flex and the user's diaphragm is pushed down. The air the user breath in expands the lungs to capacity and then some of the air is blown back out.

Scientists discovery that the reason why yawning is contagious is because in one time in evolution, it was used as a way to signal each other; therefore, when one yawns the others follow. The reason why it is still contagious is because of the leftover response that human inherited from the ancestors.

The reflex arc is thought to be in the reticular system of the brain stem and concerns the respiratory neurones in the medulla, the motor nuclei of the 5th, 7th, 10th, and 12th cranial nerves, the phrenic nerves, and the motor supply to the intercostal muscles. Neurological lesions tell us much about brain function, confirming that the yawning center is part of the reticular system because people with pontine lesions who cannot open their mouth at will are able to yawn in response to appropriate stimuli. The reticular complex is closely connected to cortical areas, the subcortical limbic center, and hypothalamus, which explains why boredom, fatigue, and the act of observing others yawning can provoke the reflex through the prefrontal associative area.

A study was done in which heart rate, skin effects, and muscle tension were measured in 30 young adults before, during, and after yawns. They found that yawning did increase their level of arousal for a short time. As s result, yawning is contagious and is good for the user's health.

According to the preferred embodiment, the method comprises the following steps.

(1) Generate a yawning influence signal periodically.

(2) Apply the yawning influence signal through a media to the user.

(3) Contagiously stimulate the user to generate a sense of yawn by means of reflex action.

In step (1), the yawning influence signal is generated in form of sound and/or image, wherein he yawning influence signal can be a sound of yawning for user to listen and/or a yawning image for the user to see.

In step (1), the method of controlling the oxygen inhaling through the involuntary action of the user further comprises a step of:

(1.1) Set a time interval for generating the yawning influence signal in cycle.

The yawning influence signal is generated within a period of time automatically, such as five minutes, or preset by the user. When the user needs more oxygen, the user is able to preset a shorter time interval, so as to increase the frequency of yawning of the user.

In step (2), in order to apply the yawning influence signal to the user, a proper media of a public communication system must be incorporated to communicate with the user. When the yawning influence signal is embodied as a sound signal, the media should be a music player, wherein the yawning influence signal is recorded in a disc or a tape so that the user is able to broadcast the yawning influence signal at home or while driving. Moreover, the user is able to tune the radio at a predetermined radio frequency of a radio channel so that the yawning influence signal is capable of broadcasting through the radio channel.

When the yawning influence signal is embodied as an image signal, the yawning influence signal can be broadcasted through the television. It is worth mentioning that a source of the yawning influence signal can be sent out through Internet such that the user is able to subconsciously receive the yawning influence signal while working. In other words, the user is able to download the yawning influence signal to his or her computer system or connect to a service center where the yawning influence signal is stored therein through the computer system.

As it is mentioned above, yawning is contagious so that when the user receives the yawning influence signal, in step (3), the sense of yawn is generated from the user to perform the involuntary action of the yawning, so as to inhale the air into the user's lung for enhancing the oxygen level of the user's body.

It is worth mentioning that the yawning influence signal in sound form can create a yawning environment to influence the user to generate the sense of yawn while the yawning influence signal in image form can create an eye contact to stimulate the user to generate the sense of yawn. Due to the reflex action, which is one in which a muscular movement occurs in immediate response to a sensory stimulation without the interposition of consciousness, the user is subconsciously stimulated by the yawning influence signal to generate the sense of the yawn.

Since yawning is one of the involuntary actions, the user subconsciously inhales oxygen in his or her body to increase the oxygen level thereof, so as to increase the level of arousal without disturbing the user's activities. For example, a driver is able to incorporate the present invention during driving such that the sense of yawn is generated for mind stimulation purpose without affecting the concentration of driving. Likewise, a writer is able to broadcast the yawning influence signal through the computer to enhance the mind activities without disturbing the brainwave of writing.

The present invention further comprises an oxygen inhaling control system for the user through the involuntary action thereof, which comprises means for storing the yawning influence signal, wherein the storing means is capable of being converted the yawning influence signal to a human receivable signal through the media, so as to contagiously stimulate the user to generate the sense of yawn by means of reflex action.

According to the preferred embodiment, the storing means can be a compact disc to store the yawning influence signal as a computer readable data in such a manner that the yawning influence signal is capable of converting through the computer system and/or being played through an audio system installed into a vehicle. The storing means can also be a web site such that the user is able to connect to the web site through Internet to broadcast the yawning influence signal.

In addition, the yawning influence signal is stored in the storing means in a predetermined sequence manner that the yawning influence signal is periodically generated for applying to the user through the media with a predetermined time interval.

What is claimed is:

1. A method of controlling oxygen inhaling through an involuntary action of a user, comprising the steps of:
(a) generating a yawning influence signal periodically;
(b) applying said yawning influence signal through a media to said user; and
(c) contagiously stimulating said user to generate a sense of yawn by means of reflex action.

2. The method, as recited in claim 1, wherein said yawning influence signal is a yawning sound signal to create a yawning environment for influencing said user to generate said sense of yawn.

3. The method, as recited in claim 1, wherein said yawning influence signal is a yawning image signal to create an eye contact for stimulating said user to generate said sense of yawn.

4. The method, as recited in claim 1, wherein said yawning influence signal contains a yawning sound signal and a yawning image signal to create a yawning environment with an eye contact for stimulating said user to generate said sense of yawn.

5. The method as recited in claim 1, in step (1), further comprises a step of setting a time interval for generating said yawning influence signal in cycle.

6. The method as recited in claim 2, in step (1), further comprises a step of setting a time interval for generating said yawning influence signal in cycle.

7. The method as recited in claim 3, in step (1), further comprises a step of setting a time interval for generating said yawning influence signal in cycle.

8. The method as recited in claim 4, in step (1), further comprises a step of setting a time interval for generating said yawning influence signal in cycle.

9. The method, as recited in claim 1, wherein said yawning influence signal is transmitted through a public communication system as said media.

10. The method, as recited in claim 2, wherein said yawning influence signal is transmitted through a public communication system as said media.

11. The method, as recited in claim 3, wherein said yawning influence signal is transmitted through a public communication system as said media.

12. The method, as recited in claim 4, wherein said yawning influence signal is transmitted through a public communication system as said media.

13. An oxygen inhaling control system for a user, comprising:
a yawning influence signal; and
means for storing said yawning influence signal, wherein said storing means is capable of being converted said yawning influence signal to a human receivable signal through a media so as to contagiously stimulate said user to generate a sense of yawn by means of reflex action.

14. The oxygen inhaling control system, as recited in claim 13, wherein said yawning influence signal is a yawning sound signal to create a yawning environment for influencing said user to generate said sense of yawn.

15. The oxygen inhaling control system, as recited in claim 13, wherein said yawning influence signal is a yawning image signal to create an eye contact for stimulating said user to generate said sense of yawn.

16. The oxygen inhaling control system, as recited in claim 13, wherein said yawning influence signal contains a yawning sound signal and a yawning image signal to create a yawning environment with an eye contact for stimulating said user to generate said sense of yawn.

17. The oxygen inhaling control system, as recited in claim 13, wherein said yawning influence signal is stored in said storing means in a predetermined sequence manner that said yawning influence signal is periodically generated for applying to said user through said media with a predetermined time interval.

18. The oxygen inhaling control system, as recited in claim 14, wherein said yawning influence signal is stored in said storing means in a predetermined sequence manner that said yawning influence signal is periodically generated for applying to said user through said media with a predetermined time interval.

19. The oxygen inhaling control system, as recited in claim 15, wherein said yawning influence signal is stored in said storing means in a predetermined sequence manner that said yawning influence signal is periodically generated for applying to said user through said media with a predetermined time interval.

20. The oxygen inhaling control system, as recited in claim 16, wherein said yawning influence signal is stored in said storing means in a predetermined sequence manner that said yawning influence signal is periodically generated for applying to said user through said media with a predetermined time interval.
